(19) United States
(12) Patent Application Publication
(10) Pub. No.: US 2010/0209612 A1
(43) Pub. Date: Aug. 19, 2010

(54) SILYL-FUNCTIONAL LINEAR PREPOLYMERS, PRODUCTION AND USE THEREOF

(76) Inventors: Haitao Rong, Darmstadt (DE); Peter Grejwe, Heidelberg (DE); Jürgen Groll, Aachen (DE); Christine Mohr, Bebra (DE); Marina Glesius, Ohers-Roomsladt (DE); Martin Möller, Aachen (DE)

Correspondence Address: Henkel Corporation, 10 Finderne Avenue, Bridgewater, NJ, 08807, US

(21) Appl. No.: 12/708,573

(22) Filed: Feb. 19, 2010

Related U.S. Application Data
(63) Continuation of application No. PCT/EP2008/060193, filed on Aug. 4, 2008.

(30) Foreign Application Priority Data
Aug. 22, 2007 (DE) 10 2007 039 665.3

(51) Int. Cl. B05D 3/00; C08L 83/00; C07F 7/02

(52) U.S. Cl. 427/331; 524/858; 524/588; 427/399; 549/215

(57) ABSTRACT

The invention relates to coatings with a contact angle hysteresis in water as measured by the tilting plate method of at most 20° made from silyl-terminated linear prepolymers which may cross-link with the surface of the substrate for coating, wherein the silyl-terminated linear prepolymers may be obtained by reaction of compounds of general formula (I): X-A-X′ (I), where A=a polyoxyalkylene chain of ethylene oxide units or ethylene oxide and propylene oxide units with a maximum fraction of 50 wt. % of propylene oxide units based on the weight of A, X═OH, NH₂, NHR, NR₂ or OR, wherein R independently=a linear or branched 1-10 C alkyl, a 6-10 C alkaryl or aralkyl or a 5-10 C aryl and the compound of general formula (I) has a number average molecular weight of at least 100 g/mol, with compounds of general formula (II) Y—B—Si(OR¹)ᵣ(R²)₃₋ᵣ, where Y=a group reactive with OH, NH₂, NHR and/or NR₂, B=a chemical bond or a divalent low-molecular weight organic group with preferably 1-50 carbon atoms, OR¹=a hydrolysable group, R²=a linear or branched 1-6C alkyl and r=a number from 1 to 3 and optionally unreacted hydrogen atoms on the group X and/or the group X′ are optionally alkylated. The invention further relates to the production of such coatings and the use of the silyl-terminated linear pre-polymers from production of such coatings and application in mixtures with stellate silylated prepolymers.

### CROSS REFERENCE TO RELATED APPLICATIONS

The present application is a continuation of International Patent Application No. PCT/EP2008/060193 filed 4 Aug. 2008, which claims priority to German Patent Application No. 10 2007 039 665.3 filed 22 Aug. 2007, both of which are incorporated herein by reference.

The present invention relates to coatings based on silyl-functional prepolymers based on polyalkylene oxide which carry hydrolysable silyl end groups on their free ends, as well as the production of coatings based thereon. Moreover, the invention relates to the use of these prepolymers in multiple application areas.

In a variety of applications, such as medicine, bioanalysis, cosmetics, industrial equipment, textile finishing, washing agents for fabrics, household, hygiene and the field of antifouling, there exists a need to treat surfaces so that they repel soils and microbial contaminants (e.g., proteins or cells) (soil repellency) or facilitate their release/washability (soil release). As soil, proteins, diverse polymers or cells tend to adhere unusually well to hydrophobic materials, there is a particular need for hydrophilically treated surfaces.

One of the most effective hydrophilic coatings up to now are hydrogel coatings based on polyethylene oxides or polyethylene glycols. Various methods have been proposed for production of these types of coatings.

WO 9952574 A1 describes a biomolecule repellent coating produced by immobilizing a linear polyethylene glycol whose end-groups had been modified with trichlorosilane, on glassy surfaces.

Hydrogel coatings are described in WO 9112886 A1 and WO 9325247 A1, which were produced from star-shaped polyethylene oxides by the use of electron beam radiation.

EP 335308 A2 describes use of prepolymers of polyethylene oxide diols and triols whose terminal OH groups had been capped with polyisocyanates, for producing coatings having low non-specific protein adsorption.

WO 03063926A1 discloses an ultra-thin hydrogel coating produced from star-shaped isocyanate terminated prepolymers with polyether polymer arms. Such hydrogel coatings efficiently suppress non-specific protein absorption onto surfaces treated with them.

In addition, DE 102004031938 A1 and DE 10332849 A1 describe use of such hydrogel coatings in the hygiene and bioanalytical fields.

Although hydrogel coatings known from the prior art decrease cell and protein adsorption in varying degrees, often the complicated manufacturing processes for these coatings prevent them from being widely used.

These include, for example, use of reactive, poorly manageable or only elaborately synthesizeable coating materials, use of high cost irradiation units, or compulsory use of adhesion promoters, thereby resulting in costly coating processes.

Production of hydrogel coatings that are stably covalently anchored to substrate surfaces and produced in a simple manner without use of adhesion promoters, thereby permitting a significant simplification of the coating processes and opening up a broad spectrum of applications, is not known from the prior art.

Consequently, there is a need to improve manufacturing processes of these types of hydrogel coatings, particularly without the addition of adhesion promoters while still affording coatings that exhibit long-term stability.

In addition to a reduction in the tendency for adhesion by microorganisms, it is advantageous from a cleaning perspective to provide surfaces with hydrophilic properties, as such surfaces can be easily wetted with conventional water-based wash liquids, thereby facilitating soil release processes. At the same time these surfaces ought to be equipped so that after wetting water can run off as completely as possible, thereby not leaving any water film on the surface.

Hydrophilic surfaces known from the art are more or less completely wetted by water or water-based cleaning liquids. However, the water either forms a stable film on the surface or only runs off to a minor extent. This has the disadvantage in that, on drying out, a water film remains as residual soiling on the surface. Thus, mineral deposits such as lime scale deposits remain, inter alia, that tend to promote resoiling—also by proteins and microorganisms. Therefore there is a need for hydrophilic surfaces that facilitate wetting and soil release but which at the same time are easily “dewetted” from a water film.

A water-dewetting coating based on perfluoropolyethers and silica (from tetraethoxysilane, TEOS) is known from Fabbri et al., J. Sol-Gel Science and Technologie, 34 (2005) pp. 155-163; however, this coating has a large water contact angle (i.e., a relatively high hydrophobicity). Fluorine-free and pure TEOS coatings (i.e., SiO_{2-x/2}(OH)ₓ) are also described by Fabbri et al., and exhibit a hysteresis of 3.6° at contact angles of about 56-58°.

The present invention overcomes the disadvantages of the prior art regarding high hydrophobicity and low dewetting properties by providing coatings having a contact angle hysteresis with water, as measured by the tilting plate method, of at most 20°, wherein the coatings are manufactured from crosslinkable silyl-terminated linear prepolymers that cross-link with each other and with the surface of the substrate coated. The silyl-terminated linear prepolymers may be obtained by reacting compounds of general formula (I)—

X-A-X′ (I)

wherein A is a polyoxyalkylene chain of ethylene oxide units or ethylene oxide and propylene oxide units containing a maximum fraction of 50 wt. % of propylene oxide units based on the weight of A; X is OH, NH₂, NHR, NR₂ or OR, wherein the R groups are independently a linear or branched alkyl group containing 1 to 10 carbon atoms, an alkaryl or aralkyl group containing 6 to 10 carbon atoms or an aryl group containing 5 to 10 carbon atoms; and X′ is OH, NH₂, NHR or NR₂, wherein the R groups are independently a linear or branched alkyl group containing 1 to 10 carbon atoms, an alkaryl or aralkyl group containing 6 to 10 carbon atoms or an aryl group containing 5 to 10 carbon atoms; wherein the compound of general formula (I) has a number average molecular weight of at least 100 g/mol,
with compounds of general formula (II)—

Y—B—Si(OR¹)ᵣ(R²)₃₋ᵣ (II)

wherein Y is a group that is reactive towards OH, NH₂, NHR and/or NR₂; B is a chemical bond or a divalent, low molecular weight organic group containing preferably 1 to 50 carbon atoms; OR¹ is a hydrolyzable group; R² is a linear or branched alkyl group containing 1 to 6 carbon atoms; and r is a number from 1 to 3; wherein, where appropriate, unreacted hydrogen atoms on group X and/or group X′ are optionally alkylated.

Preferred embodiments of the coating according to the invention are described herein below.

Water wettability of coatings according to the invention is a sensitive measure for their hydrophilicity or hydrophobicity. The contact angle of a water droplet on a planar substrate in the surrounding medium air results from the surface energies of the coating and the water, as well as from the interfacial energy between the water and coating according to Young's equation. Contact angle tends towards 0° for maximum hydrophilicity, and tends towards 180° for maximum hydrophobicity. In practice, the advancing contact angle and receding contact angle are often measured. In the ideal case, the difference between them is zero. In reality, however, there tends to be a difference (also referred to as contact angle hysteresis) attributed to surface roughness, inhomogeneities and contamination.

Coatings according to the invention preferably have a static water contact angle as determined by the sessile drop method (see the Examples for the procedure) of at most 90°, preferably at most 70°, particularly preferably at most 55° and quite particularly preferably at most 45°. In many cases, water contact angles of 40° and less are also achieved.

Coatings according to the invention preferably have a contact angle hysteresis with water, as determined by the tilting plate method (see the examples for the procedure), of at most 15°, particularly preferably at most 12° and quite particularly preferably at most 10°. In further preferred cases, however, contact angle hysteresis of at most 4°, 3° or 2° and less are also achieved.

Silyl-terminated linear prepolymers used to produce coatings according to the invention can be obtained from the reaction of compounds of general formula (I) with those of general formula (II).

If Y is a halogen atom, preferably a chlorine atom, in compounds of the general formula (II), then B preferably is a chemical bond. The corresponding agent of formula (II) is then a monohalosilane.

If Y is NCO, a carboxylic acid anhydride group, a carboxylic acid chloride group, an acrylate group, an aldehyde group, an epoxy group, or a haloalkyl group in compounds of general formula (II), then B preferably is a divalent organic group containing 1 to 50, preferably 1 to 10, particularly preferably 1 to 3 carbon atoms.

Compounds of general formula (II) include those functional silane derivatives capable of reacting with OH and NH₂ groups. Examples include acrylate-silanes such as 3-acryloxypropyltrimethoxysilane, acryloxymethyl-triethoxysilane and (acryloxymethyl)methyldimethoxysilane, isocyanatosilanes such as 3-isocyanatopropyltrimethoxysilane, 3-isocyanato-propyltriethoxy-silane, (isocyanatomethyl)methyldimethoxysilane and isocyanatomethyl-trimethoxysilane, aldehyde-silanes such as triethoxysilylundecanal and triethoxysilylbutyraldehyde, epoxy-silanes such as 3-glycidoxypropyl-trimethoxysilane, anhydride-silanes such as 3-triethoxysilylpropylsuccinic anhydride, halo-silanes such as chloromethyltrimethoxysilane and (3-chloropropyl)methyldimethoxysilane, hydroxy-silanes such as hydroxymethyltriethoxysilane, as well as tetraethyl silicate (TEOS) (commercially available from, for example, Wacker Chemie GmbH (Burghausen), Gelest, Inc. (Morrisville, USA) or ABCR GmbH & Co. KG (Karlsruhe)) or can be manufactured by known processes. Isocyanato-silanes or anhydride silanes are particularly preferred. The complete reaction of all hydroxyl ends with isocyanato silanes affords fully silylated prepolymers. In such a case, group B represents the atom group between the isocyanate group and silyl group in the starting isocyanato silane. The complete reaction of all hydroxyl ends with anhydride silanes, for example, 3-triethoxysilylpropylsuccinic anhydride, likewise affords fully silylated prepolymers. In such a case, group B represents the atom group between the anhydride group and silyl group in the starting anhydride silane.

If the X and X′ groups in the general formula (I) are OH, NH₂ or NHR, then reaction with compounds of the general formula (II) usually occurs either with cleavage of the bond HY, such as in the case of the reaction of an OH group with a monohalo silane (B=chemical bond), or alternatively, by addition such as in the case of the reaction of an OH group with an isocyanato silane (formation of a urethane).

If groups X and X′ represent NR₂, then reaction with compounds of the general formula (II) affords quaternized products.

Groups X and X′ independently preferably represent OH, NH₂ or NHR, particularly preferably OH or NH₂.

The R group in NHR, NR₂ and OR groups preferably is a linear or branched alkyl group containing 1 to 10, preferably 1 to 6 carbon atoms.

In the reaction between compounds of formula (I) and compounds of formula (II), at least one hydrogen atom, preferably up to four hydrogen atoms from the OH and/or NH₂ groups, react with one molecule of the compound of general formula (II) such that at least mono-silylated, in the case of diamino compounds of the general formula (I), up to tetra-silylated prepolymers are formed.

Suitable exemplary compounds of formula (I) include dihydroxy terminated polyoxyalkylene diols, diamino terminated polyoxyalkylene diamines, monohydroxy-monoamine terminated polyoxyalkylene monol monoamines, monohydroxy-monoalkoxy terminated polyoxyalkylene monols or monoamino-monoalkoxy terminated polyoxyalkylene monoamines, among which the diamines and diols are preferred.

If group A of compounds according to formula (I) represents a polyoxyalkylene chain of ethylene oxide and propylene oxide units, then the maximum fraction of propylene oxide units is preferably 40 wt. % and particularly preferably maximum 30 wt. %, based on the weight of A.

Ethylene oxide and propylene oxide units found in copolymers of general formula (I) can be distributed statistically or sequentially or be in at least two blocks.

In the group(s) OR, R can represent an alkyl group or a —C(═O)-alkyl group. OR¹ is particularly preferably an alkoxy group, quite particularly preferably a methoxy or ethoxy group. The value of r is 1, 2 or 3, preferably 2 or 3 and particularly preferably 3.

In a preferred embodiment, B in the general formula (II) comprises at most one urethane, ester, ether, amine or urea group, and particularly preferably is free of them.

In a further preferred embodiment, a part or all of the OH and/or NH₂ groups that have neither reacted with the compound of Formula (II) nor been alkylated are reacted with compounds possessing a functional group reactive towards OH and/or NH₂ groups, and have another reactive group chosen from isocyanate groups, (meth)acrylate groups, oxirane groups, alcoholic OH groups, primary and secondary amino groups, thiol groups and silane groups.

The number average molecular weight of the compound of formula (I) is preferably 100 to 50,000 g/mol, particularly preferably 500 to 30,000 g/mol, quite particularly preferably 1000 to 20,000, even better 2000 to 18,000 g/mol, and can be measured by end group determinations as described in the experimental part.

Coatings according to the invention can additionally comprise one or more entities chosen from biologically active substances, pigments, colorants, fillers, silica units, nanoparticles, organofunctional silanes, biological cells, receptors or receptor-carrying molecules or cells that are physically embedded and/or covalently bonded to or in these.

Examples of such entities include bioactive materials such as active substances, biocides, oligonucleotides, peptides, proteins, signalling substances, growth factors, cells, carbohydrates and lipids, inorganic components such as apatites and hydroxyl apatites, quaternary ammonium salt compounds, compounds of bisguanidines, quaternary pyridinium salt compounds, compounds of phosphonium salts, thiazoyl benzimidazoles, sulfonyl compounds, salicylic compounds and organometallic and inorganometallic compounds. Antibacterial active substances are preferred, such as peptides, metal colloids and quaternary ammonium and pyridinium salt compounds.

Another important group of entities is illustrated by organofunctional silanes of the type (R′)₁₊ₓSi(OR″)₃₋ₓ (x=0, 1 or 2). They are characterized by both the presence of silicic acid ester groups (OR″) which hydrolyze in aqueous solution to condensable silanol groups (Si—OH), and hydrolysis-stable Si—R′ bonds on the same silicon atom, wherein the latter hydrolysis-stable bond is generally a covalent Si—C single bond. The cited functionalized silanes are often low molecular weight compounds; however, oligomeric or polymeric compounds are also included in the term “organofunctional silanes”. What is important is that both Si—OR″ groups that can be hydrolyzed to silanol groups, as well as non-hydrolyzable groups Si—R′, are present in the same molecule. By usually organic R′ group of the functionalized silanes, the whole range of additional chemical functionalities can be incorporated into coatings described here. For example, cationic binding groups (e.g., —NR′″₃⁺ groups), anionic binding groups (e.g., —SO₃⁻), redox active groups (e.g., quinone/hydroquinone groups), chromophoric groups (e.g., azo dye molecules, brighteners based on stilbene), groups having biological/pharmacological activity (e.g., saccharide or polysaccharide moieties, peptides or protein units and other organic structural motifs), groups for covalently binding onto substrates (e.g., epichlorohydrin groups, cyanuric acid chloride cystine/cysteine moieties and the like), bactericidal groups (e.g., NR′″₃⁺ groups with very long R′″ alkyl groups), catalytically active groups (e.g., transition metal complexes containing organic ligands) can be incorporated in this way into the coating layer. Additional groups that can be incorporated by means of the R′ group include, epoxy, aldehyde, acrylate and methacrylate groups, anhydride, carboxylate or hydroxy groups. Functionalities described here should be understood as merely exemplary, and in no way as being a complete list. Organosilanes therefore simultaneously serve as crosslinking aids as well as providers of functionality. In this way an inventive hydrogel coating having the desired functionality can be obtained directly.

The entities also include nanoparticulate metal or metalloid oxides. Suitable examples include silicon, zinc, titanium, aluminum, and zirconium. Silicon oxide particles with a diameter of about 1 to 500 nm are particularly preferred. Such SiO₂ particles, including their surface modified or functionalized derivatives, can contribute to improved mechanical properties of the coating layers.

Inorganic pigments represent a further group of entities. The inventive coatings containing reactive silyl groups easily bind to them through stable covalent bonds. If an inventive hydrogel (i.e., an inventive coating blended with pigments) is applied to a surface to which the hydrogel can bind, bonded, pigmented surface coatings are obtained. When organic pigments are to be incorporated into the hydrogel, or when an adhesion of the hydrogel to organic surfaces should be ensured, then organic silanes containing the appropriate adhesive groups (e.g., cationic groups as described above) can be integrated into the coating according to the invention. In this way compositions and methods are possible that enable pigments to be firmly anchored to hair, for example. If mica or effect pigments (pearlescent pigments) are fixed onto hair, then special visual effects can be produced (e.g., “glitter hair”). By using colored inorganic or organic pigments (e.g., lapis lazuli, pyrrolo pyrroles), particularly intensive or stable hair colors are obtained.

The entities are preferably incorporated by co-adsorption from solutions comprising silyl-terminated linear prepolymers or inventive mixtures and the foreign matter. Moreover, the silyl-terminated linear prepolymers or the inventive mixtures can be chemically reacted with the cited bioactive materials or, be deposited onto the surface as a mixture with unmodified silyl-terminated linear prepolymers or the inventive mixtures for the reaction. Of course, it is also possible to specifically deposit the foreign matter onto the finished inventive hydrogel coating by physisorption or chemisorption.

Fundamentally, there are no limitations on the substrates to be coated with the inventive coating. The substrates can be regularly or irregularly shaped, smooth or porous surfaces.

Exemplary suitable surface materials include glassy surfaces such as glass, quartz, silicon, silicon dioxide or ceramic, or semiconductive materials, metal oxides, metals and metal alloys such as aluminum, titanium, zirconium, copper, tin and steel. Composites such as glass fiber reinforced or carbon fiber reinforced plastics (GFP, CFP), polymers such as polyvinyl chloride, polyethylene, polymethylpentenes, polypropylene, general polyolefins, elastomeric plastics such as polydimethylsiloxane, polyesters, fluoropolymers, polyamides, polyurethanes, poly(meth)acrylates as well as copolymers, blends and composites of the above cited materials are also suitable substrates. Furthermore, cellulose and natural fibers such as cotton fibers, wool and hair can also be used as substrates. Mineral surfaces such as paints or jointing material can also serve as substrates. For polymer substrates, it is advisable in some cases to pretreat the surface. Particularly preferred substrate materials are glassy or standard inorganic surfaces wherein a fixing is directly produced through a relatively hydrolysis-stable bond (e.g., Si—O—Si or Si—O—Al) and thus a surface pre-treatment is not required. When an immediate formation of (hydrolysis stable) covalent bonds between hydrogel and substrate does not occur as described above (for example, in the case of organic substrate surfaces wherein Si—O—C bonds are prone to hydrolysis), then binding can be obtained by adding organofunctional silanes carrying binding groups. Suitable binding groups include cationic trimethylammonium groups or amino groups. Due to the concomitant presence of reactive siloxy groups, these functional groups are incorporated into the hydrogel and become an integral, covalently bonded component of the coating.

Glass, ceramic, plastic and metal substrates can be used, for example, in fittings for showers, windows, aquariums, glasses, crockery, wash basins, toilets, work surfaces, or kitchen equipment, such as refrigerators or cookers with an easily cleanable, temporary or permanent finish that enables a complete water run off, as well as repells proteins and bacteria.

In one embodiment, coatings according to the invention do not comprise any additional intra-crosslinking and/or inter-crosslinking polymers. In another embodiment, coatings according to the invention can additionally comprise monomeric silanes. Preferably however, coatings according to the invention can also be used substantially free of monomeric silanes, wherein “substantially free” means that, because of the production process, traces of compounds of general formula (II) can still be present. However, these are usually below 10 wt. %, particularly preferably below 5 wt. % and quite particularly preferably below 3 wt. % based on total weight of both the silyl-terminated prepolymer and the silane.

In one embodiment, coatings according to the invention can also comprise additional silyl-terminated polymers different from those defined in claim 1. These types of silyl-terminated prepolymers can be star-shaped silyl-terminated prepolymers, for example.

In the context of this invention, star-shaped prepolymers are those in which the polymer arms are bonded to a central unit, wherein the polymer arms are essentially bonded in a star-shape or radially to the central unit in such a way that one end of the polymer arm is bonded to the central unit, whereas the other end is not bonded to it.

Such star-shaped silyl-terminated prepolymers are obtainable, for example, in which star-shaped compounds of general formula (III):

(X-A)ₘ-Z-(A-X′)ₙ (III)

wherein Z is an organo-chemical central unit that determines the number of arms of the star-shaped compound; A, X and X′ are defined as in general formula (I); the sum of n and m is a whole number≧3, preferably 3 to 20, particularly preferably 3 to 10, and quite particularly preferably 3 to 8, wherein n≧1, preferably 3 to 20, particularly preferably 3 to 10 and quite particularly preferably 3 to 8; wherein the compound of the general formula (III) has a number average molecular weight of at least 1000 g/mol, are reacted with compounds of general formula (IV):

Y—B—Si(OR¹)ᵣ(R²)₃₋ᵣ (IV)

wherein all groups as well as r are defined as in general formula (II).

When the term “prepolymer” is used in the following, it includes both linear silyl-terminated prepolymers used in coatings according to the invention, as well as the above described star-shaped silyl-terminated prepolymers.

Compounds of the general formula (III) preferably have a number average molecular weight of 1000 to 30,000, and quite particularly preferably 5000 to 20,000 g/mol. In this regard, the star-shaped prepolymer preferably comprises at least 0.05 wt. %, particularly preferably at least 0.1 wt. % and quite particularly preferably at least 0.15 wt. % silicon.

In a preferred embodiment, Z preferably stands for a glycerin group or a polyvalent sugar such as sorbitol or sucrose. In principle, however, all starter molecules used in the literature for the preparation of star-shaped prepolymers can be employed in order to form Z.

Another subject matter of the present invention is a process for manufacturing an inventive coating on a substrate, wherein a solution of a silyl-terminated linear prepolymer optionally with additional entities and optionally star-shaped silyl-terminated prepolymers, is deposited onto the substrate to be coated, there occurring beforehand, simultaneously or subsequently an at least partial crosslinking reaction between the silyl end groups and the optionally present reactive groups of the ends that do not carry silyl end groups and/or with the substrate.

In a preferred embodiment of the inventive process, before, during or after having deposited the solution of silyl terminated linear prepolymer, optionally with star-shaped silyl-terminated prepolymers, onto the substrate to be coated, a foreign material such as biologically active substances, pigments, colorants, fillers, silica units, nanoparticles, organosilanes, biological cells, receptors or receptor-carrying molecules or cells or precursors of the abovementioned entities, is brought into contact with the silyl terminated linear prepolymer and optionally with the star-shaped silyl terminated prepolymer. The deposited entities here can be physically incorporated into the network of the silyl-terminated linear prepolymers and, optionally, the star-shaped silyl-terminated prepolymer, or be ionically bonded onto the surface of the coating through van der Waals forces or hydrogen bonds, or alternatively are bonded chemically through covalent bonds, preferably through reactive end groups of the silyl terminated linear prepolymer and/or the optionally comprised star-shaped silyl terminated prepolymers.

If silica units are incorporated as the entities into the coating, then this can be carried out by blending a solution of the silyl terminated linear prepolymers and optionally comprised star-shaped silyl terminated prepolymers with a hydrolysable silica precursor, such as a tetraalkoxysilane (e.g., tetraethoxy orthosilane; TEOS), preferably in the presence of a catalyst such as an acid or a base. The weight ratio of SiO₂ of the incorporated silica units based on the polyethylene/polypropylene oxide fraction in the coating is preferably 0.01 to 100, particularly preferably 0.5 to 50, and quite particularly preferably 0.5 to 10. In this regard, the silica units can bind to the prepolymers through van der Waals bonds ionically or through hydrogen bonding.

Binding of the silica units to each other can occur in the coating by hydrogen bonding or by ionic interactions. However, covalent —Si—O—Si bridges are preferred (detectable by IR or Raman spectroscopy). The effect of TEOS within the layer can be understood as a crosslinker effect, wherein layers without crosslinker (TEOS) are typically more hydrophilic (i.e., they are characterized by a lower contact angle, for example, in the range of 30°). In general it can be said that incorporation of additional crosslinkers such as TEOS or functional alkoxysilanes represents a further possibility to individually adjust the properties of the coatings.

Application of the ultra-thin hydrogel coatings onto the substrate is carried out by processes known per se, for example, by deposition of the prepolymers onto the surface to be coated from a solution of the prepolymers, wherein the prepolymers can already be partially pre-crosslinked, and by concomitant or subsequent crosslinking of the reactive groups of the prepolymers with one another and with the substrate.

In general, all known coating processes can be employed. Examples include immersion coating, spin coating, spray processes, polishing, brushing on, painting, rolling or knife coating. In order to achieve the desired properties of the coating layer, coating measures are chosen so that coating thickness preferably does not exceed about 500 μm, particularly preferably 200 μm, and quite particularly 100 p.m. Depending on the applications, a coating must simultaneously fulfill various requirements, for example, mechanical properties, water wetting and water dewetting behavior, protein and bacteria repellence and the like. For many cases, especially in the household sector, an ultra thin or thin layer of 0.1 to 100 nm, particularly from 1 to 50 nm, is often adequate to achieve the desired effects. However, for applications involving high mechanical stress on the surface, thicker layers with a layer thickness of, for example, 50-500 are desirable. Further, for some applications, for example, those including nanoparticles in the coating, greater layer thicknesses such as 1000 μm can be desirable. In contrast to other hydrophilic hydrogel coatings known from the art, hydrophilicity of hydrogel coatings according to the invention remains largely uninfluenced by layer thickness. This means that soil, protein and cell repellence properties remain conserved independent of layer thickness.

Suitable solvents for producing the solution of silyl-terminated linear prepolymers and optional silyl-terminated star-shaped prepolymers employed in the inventive process include water, alcohols, water/alcohol mixtures, an aprotic solvent or mixtures thereof.

Suitable aprotic solvents include ethers and cyclic ethers such as tetrahydrofuran (THF), dioxane, diethyl ether, tertiary, butyl, methyl ether, aromatic hydrocarbons such as xylenes and toluene, acetonitrile, propionitrile and mixtures of these solvents. If prepolymers containing OH, SH, carboxyl, (meth)acrylic and oxirane groups or similar groups as the end groups are utilized, then protic solvents are also suitable, such as water or alcohols, for example methanol, ethanol, n-propanol, 2-propanol, n-butanol and tert.-butanol, as well as their mixtures with aprotic solvents. If prepolymers containing isocyanate groups are employed then, besides the abovementioned aprotic solvents, water and mixtures of water with aprotic solvents are also suitable. The solvent is preferably water or a mixture of water with aprotic solvents.

The amount of linear silyl-terminated prepolymers for the inventive coatings or of suitable silyl-terminated prepolymers in the inventive mixtures for use in the application mixtures which are used in the inventive coating process depend on layer thicknesses most suitable for each application. Quantities of, for example, about 0.005 to 50 wt. %, preferably 0.1 to 10 wt. % are frequently sufficient. In addition, depending on substrate affinity and nature of the application, application mixtures having a higher or lower prepolymer content can also be employed. In this regard, application mixtures can also be in the form of pastes or creams, for example.

A further subject matter of the present invention is a mixture of (A) at least one silyl-terminated linear prepolymer obtained from reaction of compounds of general formula (I) with compounds of general formula (II), wherein where appropriate non converted hydrogen atoms of X and/or X′ of formula (I) are optionally alkylated, and (B) at least one silyl-terminated star-shaped prepolymer obtained from reaction of compounds of general formula (III) with compounds of general formula (IV), wherein where appropriate non converted hydrogen atoms of X and/or X′ of formula (III) are optionally alkylated.

In a particular embodiment of the inventive mixtures, OH and/or NH₂ groups that have neither reacted with the compound of Formula (II) and/or Formula (IV) nor been alkylated are reacted with compounds possessing a functional group that is reactive towards OH and/or NH₂ groups and have another reactive group preferably chosen from isocyanate groups, (meth)acrylate groups, oxirane groups, alcoholic OH groups, primary and secondary amino groups, thiol groups, and silane groups.

In particular, those coatings obtained from inventive mixtures are preferred wherein two neighboring or all B groups in the star-shaped prepolymer can form no more than one, preferably no hydrogen bonds to one another. Coatings of this type enable higher flexibility in the orientation of the polymer arms A, again resulting in a more uniform distribution of the prepolymers and affording a uniform, sealed coating.

The inventive hydrogel coatings produced using silyl-terminated linear prepolymers or mixtures according to the invention effectively prevent the adsorption of proteins and cells and can be employed for many applications, such as in the hygiene and bioanalytical field. Consequently, this type of use inter alia is also a subject matter of the present invention.

A further subject matter of the present invention is use of silyl-terminated prepolymers as employed in the inventive coatings or use of inventive mixtures in anti-soiling agents for the temporary or permanent finishing of surfaces. A prerequisite for this is hydrophilic surface behavior with a concomitant low contact angle hysteresis. Hydrophilicity of the surface firstly makes difficult the adsorption and adhesion of protein and fatty soils, and secondly permits efficient wetting with cleaning agents, thereby facilitating separation of contaminants from the substrate as compared with hydrophobic surfaces. Moreover, due to the low contact angle hysteresis, dewetting or complete run off of the cleaning solution prevents redeposition of soil onto the freshly cleaned surfaces.

A further subject matter of the present invention is use of silyl-terminated linear prepolymers as employed in the inventive coatings or use of inventive mixtures as additives in cleaning agents and washing agents for hard or soft surfaces, such as are used in sanitation or kitchen areas (automatic and manual dishwasher detergents), in order to prevent or reduce soiling or redeposition, in hair care agents, fabric treatment agents, treatment agents for walls, façades and joints, in agents for treating vehicles, such as automobiles, aircraft, ships and boats (anti-fouling) and in agents for the internal and external coating of containers in order to allow for example a loss-free emptying of the container, or in agents for coating bioreactors and heat exchangers, in order to prevent the adhesion of microorganisms, for example.

A further subject matter of the present invention is use of silyl-terminated linear prepolymers as employed in the inventive coatings or use of inventive mixtures for producing micro-arrays or sensors for bioanalytical purposes or for coating microfluid components or for coating micro canulae and capillary systems; for example, for introducing genetic material into cells. The hydrogel coating firstly allows a selective coupling of biomolecules onto the coating when said coating possesses, for example, receptors as the bonded entity; secondly, it is characterized by a particularly low affinity towards non-specific binding of biomolecules. Consequently, the hydrogel coatings are particularly suitable as a coating foundation for substrates for bioanalysis systems.

The inventive subject matters also include use of silyl-terminated prepolymers as employed in the inventive coatings or use of inventive mixtures for reducing surface friction, reducing the electrostatic charge of surfaces or fixing colorants onto surfaces. These surfaces preferably concern fabric surfaces, fiber surfaces or hair surfaces. If the coatings are applied onto fabrics, for example, then a more pleasing feel is produced; and when used on hair, combability is improved, for example. Stable hydrophilic coatings on hair, for example, prevent negative electrostatic effects over long periods. The same is also true for fabrics.

A further use of silyl-terminated linear prepolymers or the inventive mixtures is represented by use in coatings for influencing the growth or crystallization of solids on the surface. Due to their dense structure, their hydrophilicity as well as their facile chemical functionalizability—for example by entities—in principle, the biological situation during biomineralization processes can be reproduced with the inventive hydrogel layers. Formation of mussel shells from calcium carbonate (controlled by specifically structured and functionalized hydrophilic polymer layers) may be cited as an example of a typical biomineralization process. Here, nature teaches us that growth of solids from solution can be promoted and/or controlled or even prevented by the particularities of the chemical structure of such hydrophilic polymers. Lime scale crystallization on surfaces can be cited as an industrially and economically relevant growth process. Growth of lime scale can be prevented by the inventive hydrogel layers, and optionally by addition of appropriate entities. Lime scale precipitation is also prevented beyond the depicted substrate action in that water dewets from the coated surfaces as described above, and because of this simple physical effect, crystallization is prevented. The anti-lime scale coating based on hydrogel can be of a permanent or even a temporary nature.

By incorporating appropriate entities, not only the growth of solids can be prevented, but rather the targeted, optionally also crystallographically oriented, growth of solids on substrates can be induced, preferably for those with industrially useful functionalities. Accordingly, based on the chemical composition of the coating, in particular by the entities, general control of the growth of solids is possible.

Accordingly, a subject matter of the present invention is also use of silyl-terminated linear prepolymers as employed in the inventive coatings, or use of inventive mixtures for producing surface coatings having a controlled growth of solids on the coated surface.

A further use of silyl-terminated linear prepolymers or the inventive mixtures involves fixing or retaining colorants on fibers by the hydrogel coating on fabrics, either due to the structure of the hydrogel itself or by additional functionalities preferably contributed by the abovementioned entities. In this way, color protection is achieved, which can be used, for example in a “no-sort” washing agent (i.e., a washing agent that can be used for washing colored and white laundry together).

Finally, a subject matter of the present invention concerns anti-soiling agents, cleaning agents and washing agents for hard and soft surfaces, hair care agents, fabric treatment agents, wall, cladding and grouting agents, agents for the treatment of vehicles, agents for the internal and external coating of containers, bioreactors and heat exchangers, comprising silyl-terminated linear prepolymers as employed in the inventive coatings or inventive mixtures.

### EXAMPLES

In the experimental part, molecular weights are number average molecular weights of the alcohols or amines of general formulas (I) or (III) that were employed in production of the prepolymers. The number average molecular weight of the alcohols can be determined from the determination of the end groups by calculation based on known functionality of the compounds or on functionality of the components in the mixture and the OH number of the compound or mixture (determined according to DIN 53240). For amines or amine mixtures, end group determination can be made by potentiometric titration according to DIN 16945.

Examples of the synthesis of suitable silyl-terminated linear prepolymers:

### Example 1

### Linear poly(ethylene oxide-co-propylene oxide) Containing Terminal Triethoxysilyl Groups and Terminal Methoxy Groups (LPP1)

618.4 mg (1 eq.) (3-isocyanatopropyl)triethoxysilane was slowly added to 5 g (2.5 mmol) Jeffamine® M2070 (a linear statistical methoxy-terminated poly(ethylene oxide-co-propylene oxide) monoamine with an ethylene oxide/propylene oxide weight ratio of 31/10 and a number average molecular weight of ca. 2000 g/mol; obtained from Huntsman) under stirring. The reaction mixture was stirred overnight. The product comprised a triethoxysilyl group on one end of the polymer chain and a methoxy group on the other end. The product was a colorless, viscous liquid.

### Example 2

### Linear poly(ethylene oxide-co-propylene oxide) with Two Terminal Triethoxysilyl Groups (LPP2)

5 g (2.5 mmol) Jeffamine® ED-2003 (a linear poly(ethylene oxide-co-propylene oxide, amino-terminated on both ends) with an ethylene oxide/propylene oxide weight ratio of 39/6 and a number average molecular weight of ca. 2000 g/mol; obtained from Huntsman) was slowly added to 1.24 mg (1 eq.) (3-isocyanatopropyl)triethoxysilane in 10 ml tetrahydrofuran under stirring. The reaction mixture was stirred overnight. Removal of the tetrahydrofuran afforded as the product a polymer with a triethoxysilyl group on both ends of the polymer chain. The product was a waxy solid.

Examples of the synthesis of suitable star-shaped prepolymers (as the mixture component (B) of the inventive mixtures):

### Example 3

### Three-Armed Triethoxysilyl-Terminated Polyether (SPP1)

A polyether polyol (a 3-armed statistical poly(ethylene oxide-co-propylene oxide) with an EO/PO ratio of 75/25 and a number average molecular weight of ca. 5000 g/mol, obtained from DOW Chemicals under the tradename Voranol® CP 1421) was heated to 80° C. prior to the reaction with stirring under vacuum for 1 hr.

To the dried polyether polyol (2.04 g, 0.41 mmol) was slowly added the (3-isocyanatopropyl)triethoxysilane (317 mg, 1.0 eq.). The reaction mixture was stirred at 100° C. for 2 days under inert gas until disappearance of the characteristic IR peak of the NCO group. A product was obtained with a triethoxysilyl group on each end of the polymer arms of the star-shaped prepolymer. The product was a colorless, viscous liquid.

### Example 4

### Six-Armed Triethoxysilyl-Terminated Polyether (SPP2)

A polyether polyol (6-arm statistical poly(ethylene oxide-co-propylene oxide) with an EO/PO ratio of 80/20 and a molecular weight of 12 000 g/mol manufactured by anionic ring-opening polymerization of ethylene oxide and propylene oxide using sorbitol as the initiator) was heated to 80° C. prior to reaction with stirring under vacuum for 1 hr.

To a solution of polyether polyol (3 g, 0.25 mmol), triethylenediamine (9 mg, 0.081 mmol) and dibutyltin dilaurate (9 mg, 0.014 mmol) in 25 ml anhydrous toluene was added drop wise a solution of (3-isocyanatopropyl)triethoxysilane (0.6 ml, 2.30 mmol) in 10 ml anhydrous toluene. The solution was stirred overnight at 50° C. After the toluene had been removed under vacuum, the crude product was repeatedly washed with anhydrous ether. After drying under vacuum, the product obtained was a colorless viscous liquid possessing a triethoxysilyl group on each free end of the polymer arms of the star-shaped prepolymer. IR (film, cm⁻¹): 3349 (m, —CO—NH—), 2868 (s, —CH₂—, —CH₃), 1719 (s, —C═O), 1456 (m, —CH₂—, —CH₃), 1107 (s, —C—O—C—), 954 (m, —Si—O—). ¹H-NMR (benzene-d₆, ppm): 1.13 (d, —CH₃ of the polymer arms), 1.21 (t, —CH₃ of the silane end groups), 3.47 (s, —CH₂ of the polymer arms), 3.74 (q, —CH₂ of the silane end groups).

### Example 5

### Six-Armed Triethoxysilyl-Hydroxy-Terminated Polyether (SPP3)

Analogously to Example 3, to a solution of polyether polyol (10 g, 0.83 mmol), triethylenediamine (30 mg, 0.27 mmol) and dibutyltin dilaurate (30 mg, 0.048 mmol) in 50 ml anhydrous toluene was added drop wise a solution of (3-isocyanatopropyl)triethoxysilane (0.65 ml, 2.49 mmol) in 15 ml anhydrous toluene. The solution was stirred overnight at 50° C. After removing the toluene under vacuum, the crude product was analyzed by IR. The results showed that the typical vibrations of the NCO group at ca. 2270 cm⁻¹ disappeared and were accompanied by reduced OH vibrations at ca. 3351 cm^{-I}, meaning that the isocyanatosilane molecules had been successfully coupled to the end of the polyols through a urethane bond. The crude product was then repeatedly washed with anhydrous ether. After drying under vacuum, the product was obtained as a colorless viscous liquid; it possessed triethoxysilyl groups and hydroxyl groups in a statistical ratio of 3/3 on the free ends of the polymer arms of the star-shaped prepolymer. IR (film, cm¹): 3511, (m, —OH), 3351 (m, —CO—NH—), 2868 (s, —CH₂—, —CH₃), 1720 (s, —C═O), 1456 (m, —CH₂—, —CH₃), 1112 (s, —C—O—C—), 953 (m, —Si—O—). ¹H-NMR (benzene-d₆, ppm): 1.08-1.17 (m, —CH₃ of the polymer arms and —CH₃ of the silane end groups), 3.47 (s, —CH₂ of the polymer arms), 3.74 (q, —CH₂ of the silane end groups).

### Example 6

### Six-Armed Triethoxysilyl-Hydroxy-Terminated Polyether (SPP4)

Analogously to Example 3, to a solution of polyether polyol (10 g, 0.83 mmol), triethylenediamine (30 mg, 0.27 mmol) and dibutyltin dilaurate (30 mg, 0.048 mmol) in 50 ml anhydrous toluene was added drop wise a solution of (3-isocyanatopropyl)triethoxysilane (0.22 ml, 0.84 mmol) in 15 ml anhydrous toluene. The solution was stirred overnight at 50° C. After the toluene had been removed under vacuum, the crude product was repeatedly washed with anhydrous ether. After drying under vacuum, the product was obtained as a colorless viscous liquid; it possessed triethoxysilyl groups and hydroxyl groups in a statistical ratio of 1/5 on the free ends of the polymer arms of the star-shaped prepolymer. IR (film, cm⁻¹): 3494, (m, —OH), 3346 (w, —CO—NH—), 2868 (s, —CH₂—, —CH₃), 1722 (m, —C═O), 1456 (m, —CH₂—, —CH₃), 1112 (s, —C—O—C—), 952 (m, —Si—O—). ¹H-NMR (benzene-d₆, ppm): 1.08-1.18 (d, —CH₃ of the polymer arms and —CH₃ of the silane end groups), 3.49 (s, —CH₂ of the polymer arms), 3.75 (q, —CH₂ of the silane end groups).

Additional triethoxysilyl-hydroxy-terminated polyethers were produced according to Examples 5 and 6—

### Example 7

### Triethoxysilyl and Hydroxy Groups (ratio triethoxysilyl/OH=2/4: SPP5)

Colorless viscous liquid. IR (film, cm⁻¹): 3496, (m, —OH), 3351 (w, —CO—NH—), 2869 (s, —CH₂—, —CH₃), 1721 (m, —C═O), 1459 (m, —CH₂—, —CH₃), 1107 (s, —C—O—C—), 953 (m, —Si—O—). ¹H-NMR (benzene-d₆, ppm): 1.05-1.16 (m, —CH₃ of the polymer arms and —CH₃ of the silane end groups), 3.47 (s, —CH₂ of the polymer arms), 3.74 (q, —CH₂ of the silane end groups).

### Example 8

### Triethoxysilyl and Hydroxy Groups (ratio triethoxysilyl/OH=5/1: SPP6)

Colorless, viscous liquid. IR (film, cm⁻¹): 3512, (m, —OH), 3351 (w, —CO—NH—), 2867 (s, —CH₂—, —CH₃), 1715 (m, —C═O), 1457 (m, —CH₂—, —CH₃), 1116 (s, —C—O—C—), 952 (m, —Si—O—). ¹H-NMR (benzene-d₆, ppm): 1.08-1.17 (m, —CH₃ of the polymer arms and —CH₃ of the silane end groups), 3.47 (s, —CH₂ of the polymer arms), 3.74 (q, —CH₂ of the silane end groups).

### Example 9

### Triethoxysilyl and Hydroxy Groups (ratio triethoxysilyl/OH=4/2: SPP7)

Colorless, viscous liquid. IR (film, cm⁻¹): 3513, (m, —OH), 3351 (w, —CO—NH—), 2867 (s, —CH₂—, —CH₃), 1721 (m, —C═O), 1455 (m, —CH₂—, —CH₃), 1106 (s, —C—O—C—), 954 (m, —Si—O—). ¹H-NMR (benzene-d₆, ppm): 1.05-1.16 (m, —CH₃ of the polymer arms and —CH₃ of the silane end groups), 3.46 (s, —CH₂ of the polymer arms), 3.73 (q, —CH₂ of the silane end groups).

### Example 10

### Six-Armed triethoxysilyl-isocyanate-terminated Polyether (SPP8)

A mixture of the product of Example 5 (4 g, 0.32 mmol), isophorone diisocyanate, (IPDI, 3.2 ml, 15.1 mmol) and 7 ml anhydrous toluene was stirred at 50° C. for 48 hours. After the toluene had been removed under vacuum, the crude product was repeatedly washed with anhydrous ether. After drying under vacuum, the product was obtained as a colorless viscous liquid; it possessed triethoxysilyl groups and isocyanate groups in a statistical ratio of 3/3 on the free ends of the polymer arms of the star-shaped prepolymer. IR (film, cm⁻¹): 3335 (w, —CO—NH—), 2869 (s, —CH₂—, —CH₃), 2266 (s, —NCO), 1717 (s, —C═O), 1458 (m, —CH₂—, —CH₃), 1111 (s, —C—O—C—), 953 (m, —Si—O—). ¹H-NMR (benzene-d₆, ppm): 1.11-1.18 (m, —CH₃ of the polymer arms and —CH₃ of the silane end groups), 3.49 (s, —CH₂ of the polymer arms), 3.75 (q, —CH₂ of the silane end groups).

### Example 11

### Six-Armed triethoxysilyl-isocyanate-terminated Polyether (SPP9)

A mixture of the product of Example 6 (4.7 g, 0.38 mmol), isophorone diisocyanate, (IPDI, 5.65 ml, 26.7 mmol) and 5 ml anhydrous toluene was stirred at 50° C. for 48 hours. After the toluene had been removed under vacuum, the crude product was repeatedly washed with anhydrous ether. After drying under vacuum, the product was obtained as a colorless viscous liquid; it possessed triethoxysilyl groups and isocyanate groups in a statistical ratio of 1/5 on the free ends of the polymer arms of the star-shaped prepolymer. IR (film, cm⁻¹): 3335 (w, —CO—NH—), 2869 (s, —CH₂—, —CH₃), 2266 (s, —NCO), 1717 (s, —C═O), 1458 (m, —CH₂—, —CH₃), 1112 (s, —C—O—C—), 952 (m, —Si—O—). ¹H-NMR (benzene-d₆, ppm): 1.11-1.18 (m, —CH₃ of the polymer arms and —CH₃ of the silane end groups), 3.48 (s, —CH₂ of the polymer arms), 3.75 (q, —CH₂ of the silane end groups).

Additional triethoxysilyl-isocyanate-terminated polyethers were produced according to Examples 10 and 11—

### Example 12

### Triethoxysilyl and Isocyanate Groups (ratio triethoxysilyl/NCO=2/4: SPP10)

Colorless viscous liquid. IR (film, cm⁻¹): 3335 (w, —CO—NH—), 2869 (s, —CH₂—, —CH₃), 2265 (s, —NCO), 1718 (s, —C═O), 1460 (m, —CH₂—, —CH₃), 1112 (s, —C—O—C—), 952 (m, —Si—O—). ¹H-NMR (benzene-d₆, ppm): 1.1-1.17 (m, —CH₃ of the polymer arms and —CH₃ of the silane end groups), 3.48 (s, —CH₂ of the polymer arms), 3.75 (q, —CH₂ of the silane end groups).

### Example 13

### Triethoxysilyl and Isocyanate Groups (ratio triethoxysilyl/NCO=5/1: SPP11)

Colorless, viscous liquid. IR (film, cm⁻¹): 3342 (w, —CO—NH—), 2869 (s, —CH₂—, —CH₃), 2265 (s, —NCO), 1719 (s, —C═O), 1460 (m, —CH₂, —CH₃), 1114 (s, —C—O—C—), 954 (m, —Si—O—). ¹H-NMR (benzene-d₆, ppm): 1.09-1.17 (m, —CH₃ of the polymer arms and —CH₃ of the silane end groups), 3.48 (s, —CH₂ of the polymer arms), 3.75 (q, —CH₂ of the silane end groups).

### Example 14

### Triethoxysilyl and Isocyanate Groups (ratio triethoxysilyl/NCO=4/2: SPP12)

Colorless viscous liquid. IR (film, cm¹): 3340 (w, —CO—NH—), 2869 (s, —CH₂—, —CH₃), 2265 (s, —NCO), 1719 (s, —C═O), 1459 (m, —CH₂—, —CH₃), 1109 (s, —C—O—C—), 953 (m, —Si—O—). ¹H-NMR (benzene-d_{6′} ppm): 1.12-1.17 (m, —CH₃ of the polymer arms and —CH₃ of the silane end groups), 3.49 (s, —CH₂ of the polymer arms), 3.75 (q, —CH₂ of the silane end groups).

### Example 15

### Six-Armed triethoxysilyl-terminated Polyether (SPP13)

The polyether polyol was a 6-arm statistical poly(ethylene oxide-co-propylene oxide) with an EO/PO ratio of approximately 80/20 and a number average molecular weight of approximately 3000 g/mol. It was manufactured by anionic ring-opening polymerization of ethylene oxide and propylene oxide using sorbitol as the initiator. Prior to the reaction, the polyether polyol was heated to 80° C. with stirring under a vacuum for 1 hr.

To the dried polyether polyol (20 g, 6.67 mmol) was slowly added the dibutyltin dilaurate (2 mg, 0.01%) and (3-isocyanatopropyl)triethoxysilane (9.5 g, 1.0 eq.). The reaction mixture was stirred at room temperature for 2 days under inert gas until the disappearance of the IR peak of the NCO group. After drying under vacuum, the product was obtained as a colorless viscous liquid; it possessed a triethoxysilyl group on each free end of the polymer arms of the star-shaped prepolymer.

Production of the hydrogel coatings:

For production of the inventive hydrogel coatings and comparative coatings, part of the silyl-terminated linear prepolymers was added individually or inventively mixed with star-shaped prepolymers. The added prepolymer or mixture of different prepolymers (10 wt. %) was stirred with water (5 wt. %) and acetic acid (5 wt. %) in ethanol at room temperature over night (stock solution). This stock solution was then diluted with 40× water and sprayed onto glass surfaces (“ready to use” slides obtained from Karl Roth GmbH). After rinsing with running water, an inventive coating is obtained.

Experiments on hydrogel coatings:

### Measurement of the Static Water Contact Angle and the Contact Angle Hysteresis—

Measurements were carried out with a contact angle measurement device from Data Physics GmbH (type OCA20; electronic tilt device TBU90E; electronic syringe module ES; software: SCA incl. Software update for SCA modules (version 3.11.6 build 155)).

The equipment was calibrated before measurement with the automatic calibration method of the equipment. A droplet of distilled water (15 μl) was deposited by syringe module on the surface to be measured of the slide. The tilt angle was 0°, meaning, the surface to be measured was horizontal. Pictures of the droplet were taken with a video camera. In the single frame, a tangent from the cross section of the droplet to the point on which the droplet contacts the surface was calculated by the software. The resulting angle between the tangent and the surface being measured is called the static contact angle (sessile drop method).

The sample together with the sample table and camera was then tilted to an angle of 90° at the lowest speed allowable by the equipment (0.62°/s calculated from equipment data). During this procedure a video of the droplet was filmed with the camera using the software, tilt angle being recorded at the time of the filming. The measurement was terminated as soon as the droplet began to run off the surface. Using the software the advancing angle (angle in the flow direction of the droplet) and the receding angle (at the other side of the droplet) in the video were then determined using the ellipse method of the measurement software up to the time when the droplet begins to run off the surface. The difference between the two angles is the contact angle hysteresis (tilting plate method).

### Shoe Polish Test—

“Shoe polish soil” was produced as follows—A mixture of black shoe polish (6.5 wt. %), mazola oil (3.5 wt. %), gravy (26 wt. %) and tap water (64 wt. %) was boiled for 2 minutes at 100° C. After stirring for 20 minutes, it was allowed to cool down to room temperature yielding the shoe polish soil. The test surfaces were dipped into the shoe polish soil for 2 minutes. On removal, the test surfaces were dried at room temperature for 1 minute and then rinsed with flowing water until the black shoe polish soil was completely removed from the surface. The amount and distribution of the remaining soil residues (white fatty layer) on the surface was used as the criterion for the “easy to clean” effect.

### IKW Test—

The coated glass surface was covered with IKW ballast soiling (produced as described in SÖFW-Journal, 1998, 124, 1029) and dried overnight at room temperature. An untreated glass surface served as the control. After drying, the surfaces were washed off with running water. The amount and distribution of the remaining soil residues (white fatty layer) on the surface was used as the criterion for the “easy to clean” effect.

TABLE 1

| | Θ_{statistical} | Hysteresis | | |
|---|---|---|---|---|
| Coatings | (deg) | (deg) | Shoe polish Test | IKW Test |
| LPP1 | 28 | 12 | +/++ | ++ |
| LPP2 | 40 | 11 | +++ | +++ |

◯ = not better than control (=uncoated);
+ = slightly better than control;
++ = significantly better than control;
+++ = very much better than control

Terminally-monosilylated methoxy capped linear prepolymer (LPP1) provided better properties in the shoe polish test and the IKW test than an untreated glass slide, with the bis-silyl-terminated linear prepolymer (LPP2) providing optimal performance in regard to the shoe polish test and IKW test.

TABLE 2

| Coatings | Water-solubility¹ | Shoe polish Test |
|---|---|---|
| LPP2 | very good | +++² |
| SPP13 | poor | +++³ |
| LPP2/SPP13 (4/1) | very good | +++² |
| LPP2/SPP13 (1/4) | good to very good | +++² |

¹based on 40 x water diluted stock solution (see above).
²coating was carried out with the 40 x water diluted stock solution (see above).
³coating was carried out with the 40 x diluted stock solution, wherein a mixture of water and ethanol (1:1, vol.) was used instead of water for the dilution.

From the point of view of industrial application, besides the performance in the shoe polish test and IKW test, dispersibility of the polymers in water (i.e., their water-solubility) also plays a decisive role as the application mostly results from use of aqueous compositions. Having said that, a highest possible inter-crosslink density of the silylated prepolymers is beneficial to the stability of the coatings. This can be achieved by adding star-shaped silylated prepolymers. SPP13 is a star-shaped prepolymer that, however, due to its low molecular weight, is relatively hydrophobic and has a poor solubility in water. Surprisingly, its water-solubility is increased when mixed with a linear silylated prepolymer (see LPP2/SPP13 mixture), the same optimal behavior in the shoe polish test being retained.

We claim:

1. Method of preparing coatings comprising:
obtaining silyl-terminated linear prepolymers by reacting compounds of general formula (I)—
X-A-X′ (I)
wherein A is a polyoxyalkylene chain of ethylene oxide units or ethylene oxide and propylene oxide units containing a maximum fraction of 50 wt. % of propylene oxide units based on the weight of A; X is OH, NH₂, NHR, NR₂ or OR, wherein the R groups independently of each other stand for a linear or branched alkyl group containing 1 to 10 carbon atoms, an alkaryl or aralkyl group containing 6 to 10 carbon atoms or an aryl group containing 5 to 10 carbon atoms; X′ is OH, NH₂, NHR or NR₂, wherein the R groups are independently a linear or branched alkyl group containing 1 to 10 carbon atoms, an alkaryl or aralkyl group containing 6 to 10 carbon atoms or an aryl group containing 5 to 10 carbon atoms; and
wherein the compound of general formula (I) has a number average molecular weight of at least 100 g/mol,
with compounds of general formula (II)
Y—B—Si(OR¹)ᵣ(R²)₃₋ᵣ (II)
wherein Y is a group that is reactive towards OH, NH₂, NHR and/or NR₂; B is a chemical bond or a divalent, low molecular weight organic group containing 1 to 50 carbon atoms;
OR¹ is a hydrolyzable group; R² is a linear or branched alkyl group containing 1 to 6 carbon atoms; and r is a number from 1 to 3; where appropriate, unreacted hydrogen atoms on the group X and/or the group X are optionally alkylated, and
adding the silyl-terminated linear prepolymers to a coatings mixture,
wherein the coatings have a contact angle hysteresis with water as measured by the tilting plate method of at most 20°, and
wherein the silyl-terminated linear prepolymers can cross-link with each other and with the surface of the substrate to be coated.

2. Method according to claim 1 wherein Y is NCO, a carboxylic acid anhydride group, a carboxylic acid chloride group, an acrylate group, an aldehyde group, an epoxy group or a haloalkyl group, and B is a divalent organic group containing 1 to 50 carbon atoms.

3. Method according to claim 1 wherein the compound of formula (I) is a dihydroxy terminated polyoxyalkylene diol, a diamino terminated polyoxyalkylene diamine, a monohydroxy-monoamine terminated polyoxyalkylene monol monoamine, a monohydroxy-monoalkoxy terminated polyoxyalkylene monol or a monoamino monoalkoxy terminated polyoxyalkylene monoamine.

4. Method according to claim 1 wherein A is a polyoxyalkylene chain of ethylene oxide and propylene oxide units having a maximum fraction of 40 wt. % propylene oxide units, based on weight of A.

5. Method according to claim 1 wherein the static water contact angle as determined by the sessile drop method is at most 70°.

6. Method according to claim 1 wherein the contact angle hysteresis with water as measured by the tilting plate method is at most 15°.

7. Method according to claim 1 wherein the OR¹ group is an alkoxy group and r=1, 2 or 3.

8. Method according to claim 1 further comprising reacting OH and/or NH₂ groups that have neither reacted with the compound of Formula (II) nor been alkylated with compounds possessing a functional group reactive towards OH and/or NH₂ groups and having another reactive group chosen from isocyanate groups, (meth)acrylate groups, oxirane groups, alcoholic OH groups, primary and secondary amino groups, thiol groups and silane groups.

9. Method according to claim 1 wherein the number average molecular weight of the compound of Formula (I) is 100 to 50 000 g/mol.

10. Method according to claim 1 further comprising one or more entities chosen from biologically active substances, pigments, colorants, fillers, silica units, nanoparticles, organofunctional silanes, biological cells, receptors or receptor-carrying molecules or cells that are physically embedded and/or covalently bonded to or in these.

11. Method according to claim 1 wherein the coatings comprise no additional self-crosslinking polymers.

12. Method according to claim 1 wherein the coatings comprise no additional externally crosslinking polymers.

13. Method according to claim 1 wherein the coatings further comprise monomeric silanes.

14. Method according to claim 1 wherein the coatings further comprise silyl-terminated polymers different from those produced according to the reaction in claim 1.

15. Method according to claim 1 further comprising obtaining additional silyl-terminated polymers by reacting star-shaped compounds of general formula (III)—
(X-A)ₘ-Z-(A-X′)ₙ (III)
wherein Z is an organo-chemical central unit that determines the number of arms of the star-shaped compound; A is a polyoxyalkylene chain of ethylene oxide units or ethylene oxide and propylene oxide units containing a maximum fraction of 50 wt. % of propylene oxide units based on weight of A; X is OH, NH₂, NHR, NR₂ or OR, wherein the R groups are independently a linear or branched alkyl group containing 1 to 10 carbon atoms, an alkaryl or aralkyl group containing 6 to 10 carbon atoms or an aryl group containing 5 to 10 carbon atoms; X′ is OH, NH₂, NHR or NR₂, wherein the R groups are independently a linear or branched alkyl group containing 1 to 10 carbon atoms, an alkaryl or aralkyl group containing 6 to 10 carbon atoms or an aryl group containing 5 to 10 carbon atoms; the sum of n and m is a whole number≧3, wherein n is ≧1; and
the compound of general formula (III) has a number average molecular weight of at least 1000 g/mol,
with compounds of general formula (IV)—
Y—B—Si(OR¹)ᵣ(R²)₃₋ᵣ (IV)
wherein Y is a group that is reactive towards OH, NH₂, NHR and/or NR₂; B is a chemical bond or for a divalent, low molecular weight organic group containing preferably 1 to 50 carbon atoms; OR¹ is a hydrolyzable group; R² is a linear or branched alkyl group containing 1 to 6 carbon atoms; and r is a number from 1 to 3; and
wherein appropriate, unreacted hydrogen atoms on the group X and/or the group X′ are optionally alkylated.

16. Method according to claim 1 further comprising depositing the coatings mixture onto a substrate to be coated, wherein there occurs before deposition, simultaneously with deposition or subsequently after deposition an at least partial crosslinking reaction between the silyl end groups and optionally present reactive groups of ends that do not carry silyl end groups and/or the substrate.

17. Method according to claim 16 wherein before, during and/or after having deposited the coatings mixture containing the silyl terminated linear prepolymer onto the substrate to be coated, one or more entities chosen from biologically active substances, pigments, colorants, fillers, silica units, nanoparticles, organofunctional silanes, biological cells, receptors or receptor-carrying molecules or cells or precursors of the entities, are brought into contact with the silyl terminated linear prepolymer.

18. Method according to claim 15 wherein before, during and/or after depositing the coatings mixture containing the silyl terminated linear prepolymer onto the substrate to be coated, one or more entities chosen from biologically active substances, pigments, colorants, fillers, silica units, nanoparticles, organofunctional silanes, biological cells, receptors or receptor-carrying molecules or cells or precursors of the entities, are brought into contact with the silyl terminated linear prepolymer and/or the star-shaped silyl terminated prepolymer.

19. Method according to claim 16 wherein the coating thickness after the crosslinking reaction is 1 mm or less.

20. Coatings mixture comprising:
(A) at least one silyl-terminated linear prepolymer obtained by reacting compounds of general formula (I)
X-A-X′ (I)
wherein A is a polyoxyalkylene chain of ethylene oxide units or ethylene oxide and propylene oxide units containing a maximum fraction of 50 wt. % of propylene oxide units based on weight of A; X is OH, NH₂, NHR, NR₂ or OR, wherein the R groups are independently a linear or branched alkyl group containing 1 to 10 carbon atoms, an alkaryl or aralkyl group containing 6 to 10 carbon atoms, or an aryl group containing 5 to 10 carbon atoms; X′ is OH, NH₂, NHR or NR₂, wherein the R groups are independently a linear or branched alkyl group containing 1 to 10 carbon atoms, an alkaryl or aralkyl group containing 6 to 10 carbon atoms, or an aryl group containing 5 to 10 carbon atoms, and
wherein the compound of the general formula (I) has a number average molecular weight of at least 100 g/mol,
with compounds of general formula (II)
Y—B—Si(OR¹)ᵣ(R²)₃₋ᵣ (II)
wherein Y is a group that is reactive towards OH, NH₂, NHR and/or NR₂; B is a chemical bond or for a divalent, low molecular weight organic group containing preferably 1 to 50 carbon atoms; OR¹ is a hydrolyzable group; R² is a linear or branched alkyl group containing 1 to 6 carbon atoms; and r is a number from 1 to 3; and,
wherein appropriate, unreacted hydrogen atoms on the group X and/or the group X′ are optionally alkylated, and
(B) at least one silyl-terminated star-shaped prepolymer that can be obtained by reacting a star-shaped compound of the general formula (III):
(X-A)ₘ-Z-(A-X′)ₙ (III)
wherein Z is an organo-chemical central unit that determines the number of arms of the star-shaped compound; A, X and X have the same meanings as in component (A) but are independent of these; and the sum of n and m is a whole number≧3, wherein n is ≧1; and
wherein the compound of the general formula (III) has a number average molecular weight of at least 1000 g/mol,
with compounds of general formula (IV)
Y—B—Si(OR¹)ᵣ(R²)₃₋ᵣ (IV)
wherein Y, B, OR¹, R² and r have the same meanings as in component (A) but are independent of these, and
where appropriate, unreacted hydrogen atoms on the group X and/or the group X′ are optionally alkylated.

21. Anti-soiling agents, cleaning agents and washing agents for hard and soft surfaces, hair care agents, fabric treatment agents, wall, cladding and grouting agents, agents for the treatment of vehicles, agents for the internal and external coating of containers, bioreactors and heat exchangers comprising silyl-terminated linear prepolymers prepared according to claim 1.
